(19) United States
(12) Patent Application Publication
(10) Pub. No.: US 2006/0063690 A1
(43) Pub. Date: Mar. 23, 2006

(54) Laundry treatment compositions with improved odor

(76) Inventors: Jan Julien Marie-Louise Billiauw, Gentbrugge (BE); Marko Tapio Tossavainen, Antwerpen (BE); Catherine Monique Ganahl, Brussels (BE); Gaurav Saini, Kobe (JP); Maria Renee Mongeopa Bautista, Grimbergen (BE); Giovanna Di Tommaso, Brussels (BE); Regis du Moulinet D'Hardemare, Brussels (BE); Abdennaceur Fredj, Loveland, OH (US); Andre Cesar Baeck, Bonheiden (BE); James Charles Theophile Roger Burckett St. Laurent, Brussels (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/221,424

(22) Filed: Sep. 8, 2005

Related U.S. Application Data
(60) Provisional application No. 60/607,934, filed on Sep. 8, 2004.

(51) Int. Cl. C11D 3/37

(52) U.S. Cl. 510/276; 510/392

(57) ABSTRACT

Laundry treatment compositions having improved consumer acceptance e.g., in relation to phase properties and/or in relation to accomplishing high odor acceptance without over-perfuming. A liquid laundry detergent composition, comprising a non-enzymatic nitrogen-containing component that is capable of having a short-chain amine impurity, and comprising a solvent system capable of promoting dissolution of said nitrogen-containing component while minimizing the tendency of said solvent system to create amine impurity off-odors: wherein the composition comprises; the non-enzymatic nitrogen-containing component wherein said component is comprises less than about 10 ppm of the short-chain amine impurity; and the solvent system; and wherein the composition further comprises at least one of the following conditions: (i) the composition is substantially free of enzyme; (ii) the composition comprises a compatible enzyme preparation; (iii) the composition comprises an odor sweetener; (iv) the composition is substantially free of condensed phases which are capable of decomposing said non-enzymatic nitrogen-containing compound in the detergent composition to produce short-chain amine impurities; and/or (v) said non-enzymatic nitrogen-containing component is purified prior to incorporation into said liquid laundry detergent composition.

### CROSS REFERENCE TO RELATED APPLICATION

This application claims the benefit of priority to U.S. Application Ser. No. 60/607,934, filed Sep. 8, 2004.

### FIELD OF THE INVENTION

The present invention relates to stable liquid laundry detergents including non-enzymatic nitrogen-containing compounds, for example, nitrogen-containing fabric benefit agents such as a long-chain alkyltrimethylammonium compound or its fatty acid ion pair, and solvents.

### BACKGROUND OF THE INVENTION

There exists a need for liquid laundry detergent compositions which have improved stability, cleaning capability, fabric benefit e.g., softening, and are aesthetically pleasing (both odor and appearance). This technical problem is a surprisingly difficult one because factors affecting the liquid detergent composition formula stability can adversely affect odor, different compounds can precipitate under subtle system changes in manufacturing such as order of addtions, and nitrogen-containing components can be supplied in impure form or can decompose in the product. The technical problem to be solved also includes, when enzymes are present, having acceptable odor coming both from improving the non-enzymatic nitrogen-containing component and from improving the selection of enzyme preparations.

### SUMMARY OF THE INVENTION

In the preferred embodiment, the industrially useful solution to the technical problem set forth above includes all of the following: purification or odor-sweetener treatment of the non-enzymatic nitrogen-containing compound; a suitable solvent system; compatible enzymes (especially by selecting commercial enzyme preparations that are compatible herein); phase control of the liquid detergent such that no additional volatile amine impurities are released in storage by decomposition; and specific mixing sequences for promoting the manufacture of a stable product. More broadly, the invention encompasses embodiments where at least one of these individual solutions is present.

Thus the invention encompasses a liquid laundry detergent composition, comprising a non-enzymatic nitrogen-containing component that is capable of having a short-chain amine impurity, and comprising a solvent system capable of promoting dissolution of said nitrogen-containing component while minimizing the tendency of said solvent system to create amine impurity off-odors: wherein the composition comprises;

(a) the non-enzymatic nitrogen-containing component wherein said component is capable of having a short-chain amine impurity and wherein said component comprises less than about 10 ppm, preferably less than 1 ppm, more preferably less than 500 parts per billion (ppb) of the short-chain amine impurity; and

(b) the solvent system; and

(c) wherein the composition further comprises at least one of the following conditions:
(i) the composition is substantially free of enzyme;
(ii) the composition comprises a compatible enzyme preparation;
(iii) the composition comprises an odor sweetener;
(iv) the composition is substantially free of condensed phases which are capable of decomposing said non-enzymatic nitrogen-containing compound in the detergent composition to produce short-chain amine impurities; and/or
(v) said non-enzymatic nitrogen-containing component is purified prior to incorporation into said liquid laundry detergent composition.

The present invention also relates to a liquid laundry detergent composition according to above and wherein said component comprises less than about 500 ppb of said short-chain amine impurity and the liquid laundry detergent composition further comprises an additional laundry detergent component selected from: (i) perfumes; (ii) a fatty acid or salt thereof; (iii) a laundry adjunct, selected from antibacterial agents, malodor counteractants, cyclodextrins, deodorant perfume ingredients, dry fabric odor-enhancing technologies, other nonsilicone fabric softeners or enhancers, silicone fabric softeners or enhancers, deposition aids, thickeners and mixtures thereof; and (iv) mixtures thereof.

### DETAILED DESCRIPTION OF THE INVENTION

The essential and optional components of laundry treatment compositions herein, as well as composition form, preparation and use, are described in greater detail as follows:

In this description, all concentrations and ratios are on a weight basis of the laundry treatment composition unless otherwise specified. Elemental compositions such as percentage nitrogen (% N) are percentages by weight.

Molecular weights of polymers are number average molecular weights unless otherwise specifically indicated.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included.

Particle size ranges are ranges of median particle size. For example a particle size range of from 0.1 micron to 200 micron refers to the median particle size having a lower bound of 0.1 micron and an upper bound of 200 microns.

Particle size may be measured by means of known techniques such as a laser scattering technique, using a Coulter LS 230 Laser Diffraction Particle Size Analyzer from Coulter Corporation, Miami, Fla., 33196, USA.

All documents cited herein are, in relevant part, incorporated herein by reference. The citation of any document is not to be considered as an admission that it is prior art with respect to the present invention.

All measurements referenced herein are at room temperature (about 21.1° C.) and at atmospheric pressure, unless otherwise indicated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the liquid laundry treatment compositions of the present invention, unless otherwise specified. All such weights as they pertain to listed ingredients exclude carriers, diluents etc. that may occur in commercial forms of the materials, unless otherwise specified.

All documents cited are, in relevant part, incorporated herein by reference; the citation of any document is not to be construed as an admission that it is prior art with respect to the present invention.

Improved Odor

The laundry treatment compositions such as the liquid laundry detergents disclosed herein have improved odor. As used herein, “improved odor” refers to a decreased presence of volatile amine off-odor in the headspace of the composition, determined by expert perfumers using an unperfumed form of the composition, as compared to a reference composition not having each of the essential limitations of the present invention.

In general, the presence of off-odor in the headspace is readily ascertainable by perfumers of ordinary skill in the art, and can arise not only from volatile amines but also due to other impurities e.g., olefins.

Off-odors in headspace (the term being used in its conventional art-known sense, i.e., in any suitable limited volume space above the composition or raw material) can not only be ascertained by perfumers, they also can alternately be measured by techniques which do not require a perfumer or a perfume panel of skilled “noses”.

Such techniques include the use of conventional GC/MS, or any other suitably sensitive analytical method, for example so-called wet chemical methods. Perfume headspace analysis by GC is for example used extensively in U.S. 20030166497A1, Unilever. GC Headspace analysis having become a common technique is referred to in many thousands of references on the internet.

As used herein, improved odor refers in particular to decreases in amine-off odor associated with volatile amine impurities, especially dimethylamine, trimethylamine or mixtures thereof, when comparing a composition according to the invention with one not respecting the compositional and process criticalities identified herein.

1. Non-Enzymatic Nitrogen Containing Component

In general terms, the “non-enzymatic nitrogen containing component” as used herein includes any non-enzyme component, having nitrogen bonded in its structure, that is capable of having a short-chain amine impurity. This component by definition does not include chelants or polyethoxylated tetraethylenepentamines (see “chelants” and “polyethoxylated tetraethylenepentamines” listed as optional materials hereinafter) which have not exhibited the problem to any significant extent, with which the present invention is concerned. In one embodiment, the non-enzymatic nitrogen containing component in its substantially pure form is nonvolatile. Preferably it contains quaternary nitrogen and has fabric care properties, for example but not limited to, fabric softening. The non-enzymatic nitrogen containing component may also help in the cleaning of greasy soils, and the same material may be capable of acting as a cationic surfactant as well as also as a softener. As used herein, the non-enzymatic nitrogen-containing component is defined as one which must have a mimimized content of a volatile amine impurity comprising from one to about eight carbon atoms, in other words, the amine impurity comprises only short-chains. Moreover the volatile, or short-chain amine impurity must be one which is either (i) formed during manufacture of the component or (ii) formable by decomposition of the component on storage in a laundry detergent.

In principle the non-enzymatic nitrogen containing component in its broadest terms can include for example cationic surfactants, cationic softeners, nitrogen containing thickeners or nitrogen-containing fabric care performance-enhancing polymers, etc.

Preferred non-enzymatic nitrogen containing compounds include not only cationic fabric softeners or conditioners, but also any other fabric benefit agent e.g., for shape retention, elasticity maintenance, tactile feel, antistatic property etc. provided that it meets the requirements of the definition of the “non-enzymatic nitrogen containing component”.

Not included in the non-enzymatic nitrogen containing component are alkanolamine solvents and chaotropic agents, which are accounted for separately as part of the solvent system.

The preferred “non-enzymatic nitrogen containing component” is cationic. Examples include cationic softeners or cationic grease-removing surfactants, especially cocotrimethylammonium chloride. The ion-pair forms of such compounds can also be used, e.g., when the alkyltrimethylammonium chloride is combined with fatty acid anion, e.g., laurate, to form cocotrimethylammonium laurate; moreover, without being limited by theory, the invention is believed to be useful in the context of compounds analogous to the alkyltrimethylammonium salts, e.g., where one or more hydroxyethyl groups replaces methyl, or where the compound incorporates also one or more poly(alkyleneoxide) moiety (ethoxy-quats).

On the other hand, as part of the invention it is revealed that certain condensed phases comprising alkyltrimethylammonium and hydroxide ions are typically undesirable in the present detergents on account of rapid low-temperature decomposition.

2. Preferred Non-Enzymatic Nitrogen Containing Component

Alkyltrimethylammonium Fabric Softener Compounds and Hydroxyethyl or Polyethoxylated Analogs

A preferred class of non-enzymatic nitrogen containing components includes alkyltrimethylammonium cationic compounds, known in the art for grease removal and/or for fabric softening. Examples include the water-soluble alkyltrimethylammonium salts or their hydroxyalkyl or polyethoxylate-substituted analogs, preferably compounds having the formula R₁R₂R₃R₄N⁺X⁻ wherein R₁ is C₈-C₁₆ alkyl, each of R₂, R₃ and R₄ is independently C₁-C₄ alkyl, C₁-C₄ hydroxyalkyl, benzyl, or —(C₂H₄O)ₓH where x suitably is from 2 to 5, and X⁻ is an anion.

Preferably not more than one of R₂, R₃ or R₄ should be benzyl. The preferred alkyl chain length for R₁ is C₁₂-C₁₅ Preferred groups for R₂, R₃ and R₄ are methyl and hydroxyethyl.

The anion X⁻ is suitably halide such as chloride or bromide; or methosulfate, ethosulfate, acetate, tosylate, nitrate or phosphate. Other anions such as carbonate can also be useful. The anion is highly preferably not hydroxide, as will become apparent in the disclosure which follows.

Preferred include C₈-C₁₆ alkyl trimethyl ammonium cation salts of the above-identified anions, or the corresponding C₈₋₁₆ alkyl di(hydroxyethyl)-methyl ammonium salts. Preferred may be an alkyl trimethylammonium methosulphate or chloride or alkyl ethoxylalkyl ammonium methosulphate or chloride. Examples include lauryl trimethylammonium chloride, myristyl trimethylammonium bromide, coco trimethylammonium chloride, coco pentaethoxymethyl ammonium methosulphate and other derivatives in which two or more methyl groups bound to nitrogen atom are replaced by (poly)alkoxylated groups.

Other suitable materials include those listed as the water-soluble quaternary ammonium compound in U.S. Pat. No. 4,851,138 (Akzo), incorporated herein by reference.

Commercial forms of this component include ADOGEN 412™, a lauryl trimethyl ammonium chloride commercially available from Witco; Ethoquads (Akzo), such as Ethoquad 0/12 and Ethoquad HT/25; fatty dimethyl hydroxyethyl or fatty trimethylammonium salts, the commercial forms including Clariant's Praepagen HY™ (fatty alkyl dimethyl hydroxy-ethyl ammonium chloride); and Sasol/Condea's Servamine KAC™ (dodecyl trimethyl ammonium chloride).

The non-enzymatic nitrogen containing component is preferably present in an amount of from about 1 to about 10% by weight of the liquid laundry detergent composition, more preferably from about 1 to about 5%. In one embodiment, the non-enzymatic nitrogen containing component is present in amount of from about 1% to about 3%, by weight of the composition. Lower levels e.g., less than about 1%, e.g., about 0.5% can be used especially in combination with any silicone type fabric softeners such as polydimethylsiloxanes. Moreover optionally, aminosilicones can be added to the compositions as optional silicone type softeners, alone or in combination with polydimethylsiloxanes and/or deposition aids, e.g., at levels of up to about 5% though these silicone materials have typically high molecular weights and are not defined as being within the term “non-enzymatic nitrogen containing component”.

Ion Pair Complexes

It should be clear that the anions referred to above, i.e., chloride, bromide, methosulfate, etc. are commonly those used in commercial raw material forms of the non-enzymatic nitrogen-containing component, but that in the compositions herein, such anions can be replaced in part or completely, by anions derived from any of the anionic surfactants described elsewhere herein, or by soaps or fatty acid anions, in which instance, the catanion or ion-pair complex form of the non-enzymatic nitrogen containing component may be present.

Mixtures

Any mixture, in any proportion, of two or more non-enzymatic nitrogen containing components may be used.

3. Short-Chain Amine Impurity

As referred to in describing the non-enzymatic nitrogen containing component, this component is capable of containing a short-chain amine impurity, or in other terms a volatile amine impurity which is not an alkanolamine as defined in discussing the solvent system. The short chain amine impurity can be analytically determined by any known means. Commonly analysis is “as trimethylamine” or “on a trimethylamine equivalent basis”, even when the impurity is, for example, a mixture of monomethylamine, dimethylamine and timethylamine. The impurity is capable of delivering significant malodor at low levels, as can be seen from the spiking experiments described in the examples hereinafter. It is preferable to have zero amounts, or at worst, only ppm (parts per million) range levels, preferably only ppb (parts per billion) levels of this impurity in the non-enzymatic nitrogen containing component. Levels of the short-chain amine impurity include less than 10 ppm in the non-enzymatic nitrogen containing component, preferably less than 1 ppm, more preferably less than 500 ppb, more preferably still less than 100 ppb of the non-enzymatic nitrogen containing component. (The levels in the finished liquid laundry detergent are of course lower as can simply be calculated from knowledge of the level of non-enzymatic nitrogen containing component described elsewhere herein). Also to note in conjunction with this impurity is that it can occur either in the raw material used to form the liquid detergent, or it can occur in-situ in the liquid laundry detergent on account of decomposition of the non-enzymatic nitrogen containing component in the liquid laundry detergent. As part of the invention it is determined that in-product decomposition leading to malodor and coming from such in-situ decomposition can be lessened by maintaining the non enzymatic nitrogen containing component outside of a hexagonal, hydroxide-containing phase. The term “phase” herein is used as in phase chemistry, in its conventional sense. Hexagonal phases of surfactants are well-known.

4. Pretreatment of the Non-Enzymatic Nitrogen Containing Component

In order to limit the amount of the short-chain or volatile amine impurity, any known means can be used. This includes fractionation, steam-stripping, and any other pretreatment other than fractionation or steam-stripping, for example adsorption onto an adsorbent, etc. These techniques are generally known in the art. Such pretreatment can be carried out by the commercial supplier of the non-enzymatic nitrogen containing component.

5. Solvent System

The laundry treatment compositions of the present invention contain a solvent system. In general, the laundry treatment compositions contain sufficient solvent system for the laundry treatment composition to be in liquid or gel form. Levels of solvent system can range from about 0.1% to about 80%, by weight of the laundry treatment composition. The solvent system has a water part (in other words the detergent compositions herein are not generally anhydrous) and a non-water part.

Water Part

Suitable water levels are from greater than about 1% to about 50% or more of the liquid laundry detergent composition, more typically at least about 20% water. It is desirable for the water part to be larger than the nonwater part and especially for the water part to be larger than the volatile solvent component of the nonwater part.

Nonwater Part

The nonwater part of the solvent system is preferably at a level of from about 1% to no more than about 30%, preferably from about 1% to no more than about 20% of the liquid laundry detergent, and comprises ionizable hydrotropes and alcohols and also in preferred embodiments some alkanolamines. Chaotropes and other types of hydrotrope may optionally be included.

Suitable ionizable hydrotropes for use herein include sodium, potassium and alkanolammonium cumenesulfonates, toluenesulfonates, xylenesulfonates or naphthalenesulfonates. The term “ionizable hydrotrope” is used to distinguish the preferred hydrotrope from non-ionizable hydrotropes such as cyclohexanedimethanol, which has no anion form, though these might also be usable albeit not preferred. Without being limited by theory, the intention of selecting an ionizable hydrotrope is to mimimize addition of volatile hydrotrope materials in the solvent system and the ionizable hydrotrope is not volatile.

More generally the solvent system of the present invention preferably contains a hydrotrope. In one embodiment, the fabric treatment composition comprises from about 0.1% to about 20%, by weight of the composition, more typically from about 0.1% to about 5%, for example from about 0.1% to about 3% of the hydrotrope. By hydrotrope is meant most generally any water soluble ionic or non-charged organic agent other than the above-defined solvents which is formulated primarily for its “coupling effect”, helping to stably incorporate surfactants and/or fabric benefit agents into the fabric treatment composition.

Hydrotropes can operate by one or more mechanisms, typically not exclusively involving direct solvency. For example hydrotropes can interfere with close packing of surfactant molecules thereby preventing them from phase separating from the compositions. Hydrotropes which are ionic or ionizable are especially preferred in the instant compositions as noted. Without being limited by theory, it is believed that these do not contribute to solvent system volatility.

Alcohol Having Boiling-Point Above that of Methanol. Preferably Above that of Ethanol:

Suitable alcohols for use herein include a mixture of ethanol and propanediol, or propanediol and glycerol. Small amounts of methanol may be present but are less preferable as they may contribute to solvent odor. The intention is to limit especially methanol, but also ethanol as much as possible, substituting it by propanediol and/or glycerol. Alternatively, other ether-moiety free alcohols, glycol ethers and the like can be used as the alcohol having boiling point above that of methanol component. The flashpoints of the liquid detergent are suitably in compliance with standard Japan closed cup, US and Western European norms, e.g, above 40° C. in closed cup for Japan. Typical levels of the alcohol are from about 1% to about 20%, more typically from about 2% to about 20% of the composition, more typically still up to about 10% or up to about 15%.

Alkanolamine: Suitable alkanolamine meeting this requirement is monoethanolamine, though other alkanolamines such as diethanolamine and triethanolamine can also be used. Suitable levels for compositions designed to have very good freeze-thaw stability include from about 2.5% to about 7% by weight of the liquid detergent composition, though alternative embodiments can use no alkanolamine or only limited levels, e.g., about 0.1% up to about 1%, e.g., for warmer climates or where only a chlorinated water chlorine-scavenging effect of the alkanolamine is desired. In preferred embodiments of the invention the alkanolamine is in salt form, e.g., having been used to neutralize the acid form of a surfactant.

Chaotropic agent: Suitable chaotropic agent is urea. This component in general terms is optional. If used its level will typically not exceed about 5% e.g., from about 0.1% to about 5% is used.

6. Compatible Enzyme Preparation

The invention includes embodiments which are enzyme-free, including 0% by weight of the liquid detergent composition. The invention also includes embodiments which are enzyme-containing having either less than about 0.1% of an active enzyme protein, or at least about 0.0001% by weight of the liquid laundry detergent, of a compatible enzyme preparation. When the liquid laundry detergents comprise an enzyme, which is desirable, for example, in certain liquid laundry detergents used for automatic machine washing of clothes, the enzyme is in the form of a compatible enzyme preparation. It has been discovered that certain, incompatible, enzyme preparations sold for use in liquid laundry detergents, such as Maxatase® or Alcalase® are much less acceptable than others termed “compatible” ones. The compatibility is in terms of the impact of these preparations on consumer odor acceptance of the liquid laundry detergent. Without being limited by theory, this is believed to be connected with portions of the commercial enzyme preparation which are not the desired enzyme, but instead, are components of the commercial enzyme preparation which are derived from undesired components of the fermentation broth. Accordingly, when a commercial enzyme preparation designed for use in liquid laundry detergents is used herein, and especially when this preparation comprises a protease, it is found desirable to employ a compatible enzyme preparation, meaning one which has no adverse impact on dry fabric odor after the fabric or clothing has been washed.

A preferred enzyme is a protease but also one or more of the following detersive enzymes are suitable; protease, lipase, cutinase, cellulase, mannanase, pectate lyase and amylase. Detersive enzymes are described in greater detail in U.S. Pat. No. 6,579,839. Particularly preferred compositions herein contain from about 0.05% to about 2% by weight of detersive enzymes.

If used, enzymes are typically present at concentrations from about 0.0001% to about 2.0%, preferably from about 0.0001% to about 0.5%, and more preferably from about 0.001% to about 0.1%, by weight of pure enzyme (weight % of composition).

In alternate terms, expressing the enzyme content on the basis of commercial enzyme preparations rather than on a pure enzyme basis, a suitable level in the laundry compositions herein is from about 0.001% to about 10%, preferably from about 0.01% to about 5%, by weight, of a commercial enzyme preparation.

In the case of proteases, the enzyme preparation is a compatible enzyme preparation and the suitable level of active enzyme in this preparation is at least about 3.5% w/w %, preferably at least about 4.0% w/w.

Without being limited to only these embodiments, the invention encompasses the following preferred embodiments having enzymes: a liquid laundry detergent composition wherein said compatible enzyme preparation comprises a protease other than the serine protease ex. Bacillus amyloliquefaciens BPN' also called protease A. (see U.S. Pat. No. 5,030,378 incorporated by reference); a liquid laundry detergent composition wherein said compatible enzyme preparation has low dry fabric odor and comprises protease B. (See U.S. Pat. No. 4,760,025 incorporated by reference); a liquid laundry detergent composition wherein said compatible enzyme preparation is liquid and comprises at least about 3.5% weight/weight of active enzyme protein, preferably at least about 4.0% w/w; and a liquid laundry detergent composition wherein said compatible enzyme preparation comprises Y217 L variant of protease A.

Enzyme Stabilizers

Enzymes for use herein can be stabilized as is known in the art. See e.g., U.S. Pat. No. 4,537,706 or Surfactant Science Series, Marcel Dekker, NY, Vol. 67. (1997). See especially Chapter 8 and the included references.

Compounds having enzyme stabilizing utility useful herein include calcium and/or magnesium compounds, boron compounds e.g., borates, boronic acids, borate esters, peptides and peptide derivatives, polyols, low molecular weight carboxylates, relatively hydrophobic organic compounds, e.g., certain esters, diakyl glycol ethers, alcohols or alcohol alkoxylates, alkyl ether carboxylates combined with a calcium ion source, benzamidine hypochlorite, lower aliphatic alcohols and carboxylic acids, N,N-bis(carboxymethyl) serine salts; (meth)acrylic acid-(meth)acrylic acid ester copolymers, PEG; lignin compounds, polyamide oligomers, glycolic acid or its salts; poly hexa methylene bi guanide or N,N-bis-3-amino-propyl-dodecyl amine or salt; and mixtures thereof.

Typical detergents, especially liquids, will comprise from about 1 to about 30, preferably from about 2 to about 20, more preferably from about 5 to about 15, and most preferably from about 8 to about 12, millimoles of calcium ion per liter of finished composition. Any water-soluble calcium or magnesium salt can be used as the source of calcium or magnesium ions, including, but not limited to, calcium chloride, calcium sulfate, calcium malate, calcium maleate, calcium hydroxide, calcium formate, and calcium acetate, and the corresponding magnesium salts. In the alternative, natural water hardness may suffice.

Higher calcium and/or magnesium levels may assist grease cleaning and the compositions can accordingly include from about 0.05% to about 2%, by weight, of a water-soluble source of calcium or magnesium ions, or both.

In liquid compositions, the degradation by the proteolytic enzyme of second enzymes can be avoided by protease reversible inhibitors, e.g., peptide or protein types, in particular the modified subtilisin inhibitor of family VI and the plasminostrepin; leupeptin, peptide trifluoromethyl ketones, peptide aldehydes.

7. Odor Sweetener:

Suitable odor sweeteners useful herein include an alkyl halide such as methyl chloride, chloroform, dichloromethane. The odor sweetener may be used, or not used, in different embodiments. Odor sweeteners are defined to encompass (i) compounds have sweet notes, (ii) compounds which are capable of reacting with amines to quaternize them, and (iii) compounds which have both sweet notes and react with amines to quaternize them. Perfumery levels may be used or the level may be stoichiometric in relation to any free amines other than alkanolamines present in the compositions. In certain embodiments of the invention, odor sweeteners may be analytically undetectable in the vapor headspace over the liquid detergent, when these are of types (ii) or (iii) and have substantially completely reacted with any amine impurities in the liquid detergent composition.

8. Condensed Phases Capable of Decomposing the Non-Enzymatic Nitrogen Containing Compound

A recent scientific discovery never before applied in an industrially useful laundry composition is hidden in the literature in a paper on the topic of polymerizable cationic surfactants. Included in the disclosure, incorporated herein by reference and found in Jimenez et al, Langrnuir, 2002, Issue 18, pages 3767-3772, is the discovery that dodecyltrimethylammonium hydroxide when in hexagonal phase is subject to a dramatic rate increase in Hoffmann elimination reactions. A mechanistic explanation is given.

Accordingly in terms of the present invention, the non-enzymatic nitrogen containing material is preferably formulated in the liquid detergent outside of condensed phases capable of decomposing the non-enzymatic nitrogen containing compound and capable of producing this accelerated Hoffman elimination which is believed to form malodorous amine impurities in the detergent.

Such condensed phases to be avoided herein include condensed phases comprising hydroxide, condensed phases which are hexagonal and comprise alkyltrimethylammonium, or other similar condensed phases having similar Hoffman-elimination promoting effects.

Without being limited by theory, suitable ways to avoid having these undesirable phases include (i) avoiding the non-enzymatic nitrogen containing material in the form of the hydroxide salt, and (ii) respecting orders of mixing of the ingredients as exemplified in the working examples set forth below—including in particular the preferred pH provisions—and (iii) where possible, ensuring that the non-enzymatic nitrogen containing material is in the form of an ion pair or cation (including simply by having fatty acid present e.g., preferably in at least equimolar amount in comparison to the non-enzymatic nitrogen containing material).

9. Additional Laundry Detergent Components

Perfumes

The laundry treatment compositions of the present invention may contain from 0% to no more than about 0.7% perfume, preferably no more than about 0.5% perfume, more preferably no more than about 0.3% perfume especially when the composition is designed to appeal to Japanese consumers who tend to dislike strong over-perfumed detergents. Certain embodiments are perfumed. Others are not and can be sold as “unperfumed”. Optional perfumes useful herein include perfumes specifically developed for use with amine surfactants or used as malodor counteractants, as referred to in the background references. Perfumes such as those disclosed in the art can be used, see for example U.S. 20040077520A1. Perfumed microbeads, see for example U.S. 20040106536A1, or other delayed release or substantivity enhancing effect, see for example U.S. 20040116320A1 or U.S. 20040106528A1, are further optionally incorporable in the present compositions, as are the encapsulated fragrance materials of U.S. 20040072720A1, U.S. 20040072719A1, or U.S. 20040071746A1.

Fatty Acids or Salts (Soaps)

The compositions herein may contain from about 0.01% to about 20%, preferably from about 2% to about 7%, more preferably from about 3% to about 5%, by weight of the composition, of one or more fatty acids containing from about 8 to about 20 carbon atoms. The fatty acid can also contain from about 1 to about 10 ethylene oxide units in the hydrocarbon chain. Fatty acids of this type may form ion pairs or catanions with the quaternary ammonium materials, and these ion pairs or catanions can provide through the wash fabric softening benefits.

Suitable fatty acids are saturated and/or unsaturated, unsaturation (as in the case of oleic acid anion) being especially preferred for phase stability and effective incorporation into isotropic forms of the present compositions) and these can be obtained from natural sources such a plant or animal esters (e.g., palm kernel oil, palm oil, coconut oil, babassu oil, safflower oil, tall oil, castor oil, tallow and fish oils, grease, and mixtures thereof), or synthetically prepared (e.g., via the oxidation of petroleum or by hydrogenation of carbon monoxide via the Fisher Tropsch process). Examples of suitable saturated fatty acids for use in the compositions of this invention include caprylic, lauric, myristic, palmitic, stearic, arachidic and behenic acid. Suitable unsaturated fatty acid species include: palmitoleic, oleic, linoleic, linolenic and ricinoleic acid. Examples of preferred fatty acids are saturated C₁₂ fatty acid, saturated C₁₂-C₁₄ fatty acids, and saturated or unsaturated C₁₂ to C₁₈ fatty acids, and mixtures thereof. Other suitable fatty acids have branched chains as disclosed in U.S. 20040097392A1, U.S. 20040092419A1, U.S. 20040092418A1, and U.S. 20040087461A1 which are incorporated herein by reference.

Laundry Adjuncts

Chelants and Builders

Chelants useful herein are preferably incorporated at levels of from about 0.1% to about 3% of the fabric treatment composition and include the group of the organic phosphonates, such as the amino alkylene poly (alkylene phosphonates), alkali metal ethane 1-hydroxy diphosphonates, nitrilo trimethylene phosphonates, polyfunctionally substituted aromatic chelating agents, and mixtures thereof.

Preferably, the chelant is selected from diethylene triamine penta (methylene phosphonate), ethylene diamine tri (methylene phosphonate) hexamethylene diamine tetra (methylene phosphonate) and hydroxy-ethylene 1,1 diphosphonate, 1,1 hydroxyethane diphosphonic acid and 1,1 hydroxyethane dimethylene phosphonic acid.

Other suitable chelants include ethylenediamine disuccinates, hydroxyethyliminodiacetates (HEIDA), and chelants bearing one or more long-chain moieties, sometimes known as chelating surfactants.

Builders such as citrate or oxydisuccinate and which are other than fatty acids or soaps can also be used, especially preferred being water-soluble types, and if used these are typically at relatively low levels, e.g., up to about 5%, by weight of the composition.

Electrolytes other than builders or chelants, e.g., simple inorganic salts such as sodium sulfate, are preferably minimized in the instant compositions, having preferred levels below about 5%, preferably below about 1%.

Polyethoxylated Tetraethylenepentamines

Polyethoxylated tetraethylenepentamines and other similar cleaning-enhancing polymers can be used herein at art-known, typically low, levels, e.g., up to about 3% by weight of the composition.

Boron Compounds

Boron compounds such as borates can be used herein for useful buffering and/or enzyme stabilizing effects. Suitable levels are low, e.g., less than about 5% of the composition, and are known in the art.

Optionally the invention may be used with known technologies such as cyclodextrins, malodor counteractants, specific perfume materials and any other known fabric enhancing technology, e.g., silicones.

10. Visually Clear/Free From Precipitates

Preferred laundry treatment compositions of the invention include those which are substantially free of precipitates derived from either the non-enzymatic nitrogen containing component or from salted-out electrolyte. As used herein, “substantially free of precipitates” refers to compositions that contain less than about 0.01%, by weight of the composition, of precipitates.

In determining precipitates, it is not so much their mass that is of concern, as it is their optical effect on the composition which can adversely affect consumer acceptance. Therefore, better measures of precipitates include filtering the composition through a black fabric—absence of precipitates is associated with no, or only very low levels of residue, on black fabrics.

Yet another measure of precipitates is to inspect the composition visually. Visually clear compositions are those which are free from precipitates. Of course it should be understood and appreciated that desirable adjuncts exist, and which have optical effects, and which can optionally be added to the instant compositions. Such adjuncts include opacifiers.

In determining absence of precipitates in the present compositions, a composition is made for testing purposes without such adjuncts. Preferably the laundry treatment compositions herein, as examined in the absence of adjuncts of the opacifier type, contain no visibly detectable level of precipitates.

The term “precipitates” is used herein to refer not to any suspended or settled solid that can be derived from adding preformed solids (such as colloidal solids, nanoparticles, beads, clays etc.) to the present compositions, but rather, specifically, to any solid which forms as a solid in the composition on storage of what would otherwise have been a clear composition.

Two sources of precipitates herein of particular importance may occur on account of (a) electrolytes in the compositions “salting out” or crystallizing on storage. and/or (b) complexes of e.g., non-enzymatic nitrogen-containing component with fatty acid anions, or other condensed (solid) phases of the non-enzymatic nitrogen-containing component regardless of complexation, separating from the compositions on storage. Most especially adverse is formation of a condensed phase in which there is a closely packed arrangement which promotes local interaction of hydroxide ion with the non-enzymatic nitrogen-containing component. Without being limited by theory, this has both an adverse visual effect and an off-odor promoting effect.

11. Adjuncts Affecting Transparency or Opacity

The present invention allows for the incorporation of adjuncts affecting transparency or opacity of the liquid detergent, especially when such adjuncts are other than precipitates formed from the recited components of the composition. Such adjuncts include, for example, opacifiers, suspended beads, silicates and the like. The liquid detergents herein can accordingly range in transparency all the way from visually clear, through hazy, to completely opaque, or can have a clear part as well as very opaque regions.

12. Surfactants (Nonsoap Type)

Fabric treatment compositions herein, especially those used for cleaning and concurrently softening the laundry, contain surfactants, specifically those of types useful for cleaning the laundry. The surfactants may be nonsoap types or soap types.

The compositions of the invention comprise from about 1% to about 60%, preferably at least about 5% of a surfactant selected from anionic nonsoap surfactants, soap surfactant selected from fatty acids and their water-soluble soaps; nonionic surfactants and mixtures thereof; provided that fatty acids or their water-soluble soaps are not the sole surfactant, and that when said anionic surfactant is an alkylbenzenesulfonate, said alkylbenzene sulfonate is present at a level of not more than about 10%; preferably not more than about 7%. So-called amine surfactants can be used, for example alkylamidopropylamines but the invention includes embodiments from which such surfactants are absent. Other embodiments include alkylpoly(ethoxy)sulfates as at least a portion of any anionic surfactants used.

13. Anionic Surfactant (Soap or Nonsoap)

The fabric treatment compositions herein preferably include at least about 1%, by weight of the detergent composition, of an anionic surfactant, though compositions comprising only nonionic surfactant are also encompassed.

When an anionic surfactant is present, fabric treatment compositions herein may also include additional surfactants.

In one embodiment, the detergent compositions herein contain from about 5% to about 40%, alternatively from about 10% to about 20%, by weight of the detergent composition, of anionic surfactant.

In one embodiment, the anionic surfactant component contains alkyl polyethoxylate sulfates, for examples at levels of from 1% to 60%, more typically from 5% to 20%, and preferably contains other anionic surfactants, especially fatty acids or soaps.

Suitable levels of fatty acids or soaps include levels of 1% to 30%, preferably from 5% to 25%. Use of fatty acids or soaps as mixtures is preferredd.

The anionic surfactant component preferably contains not more than about 6%, by weight of the composition, of alkyl benzene sulfonates.

Incorporation of alkylpolyethoxy sulfates as anionic surfactants is important in certain preferred embodiments. Suitable levels are 1% to 30%, more typically from 2% to 15%.

Generally speaking, anionic surfactants useful herein are disclosed in U.S. Pat. No. 4,285,841, Barrat et al., issued Aug. 25, 1981, and in U.S. Pat. No. 3,919,678, Laughlin, et al., issued Dec. 30, 1975.

Useful anionic surfactants include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates, especially those obtained by sulfating the higher alcohols (C₈₋₁₈ carbon atoms) such as those produced by reducing the glycerides of tallow or coconut oil.

Other anionic surfactants herein are the water-soluble salts of: paraffin sulfonates containing from about 8 to about 24 (preferably about 12 to 18) carbon atoms; alkyl glyceryl ether sulfonates, especially those ethers of C₈₋₁₈ alcohols (e.g., those derived from tallow and coconut oil); alkyl phenol ethylene oxide ether sulfates containing from about 1 to about 4 units of ethylene oxide per molecule and from about 8 to about 12 carbon atoms in the alkyl group; and alkyl ethylene oxide ether sulfates containing about 1 to about 4 units of ethylene oxide per molecule and from about 10 to about 20 carbon atoms in the alkyl group.

Other useful anionic surfactants herein include the water-soluble salts of esters of α-sulfonated fatty acids containing from about 6 to 20 carbon atoms in the fatty acid group and from about 1 to 10 carbon atoms in the ester group; water-soluble salts of 2-acyloxy-alkane-1-sulfonic acids containing from about 2 to 9 carbon atoms in the acyl group and from about 9 to about 23 carbon atoms in the alkane moiety; water-soluble salts of olefin sulfonates containing from about 12 to 24 carbon atoms; and β-alkyloxy alkane sulfonates containing from about 1 to 3 carbon atoms in the alkyl group and from about 8 to 20 carbon atoms in the alkane moiety.

Particularly preferred anionic surfactants herein are the alkyl polyethoxylate sulfates of the formula: RO(C₂H₄O)ₓSO₃⁻M⁺ wherein R is an alkyl chain having from about 10 to about 22 carbon atoms, saturated or unsaturated, and the longest linear portion of the alkyl chain is 15 carbon atoms or less on the average, M is a cation which makes the compound water-soluble, especially an alkali metal, ammonium or substituted ammonium cation, and x is from 1 to about 15, preferably from about 1 to 7.

Other preferred anionic surfactants are the non-ethoxylated C₁₂₋₁₅ primary and secondary alkyl sulfates. Under cold water washing conditions, i.e., less than about 65° F. (18.3° C.), it is preferred that there be a mixture of such ethoxylated and non-ethoxylated alkyl sulfates.

Mixtures of the alkyl sulfates with the above-described paraffin sulfonates, alkyl glyceryl ether sulfonates and esters of a α-sulfonated fatty acids, are also preferred.

The fabric treatment compositions herein may comprise alkyl benzene sulfonates, but preferably, must comprise no more than about 6%, preferably less than about 3%, more preferably less than about 2% of alkyl benzene sulfonates. Certain preferred detergent composition embodiments herein contain no alkyl benzene sulfonates. Alkylbenzene sulfonates when used include those in which the alkyl group contains from about 9 to about 15 carbon atoms, in straight chain or branched chain configuration, e.g., those of the type described in U.S. Pat. No. 2,220,099 and No. 2,477,383.

When incorporating alkylbenzenesulfonates in the present compositions, it is preferable to employ alkylbenzenesulfonate mixtures comprising a large number of positional isomers with respect to attachment of the benzene ring to the alkyl chain; with respect to the position of sulfonation on the benzene ring, and with respect to the presence of other alkyl branching. This is believed to disrupt the packing and perfection of crystallinity of the alkylbenzenesulfonate, especially when it occurs in a catanion form with the non-enzymatic nitrogen containing component. Other useful alkylbenzensulfonates include those derived from alkanolamine-neutralized LAS as taught in U.S. 20040053805A1.

On the other hand, highly linear straight chain alkylbenzene sulfonates in which the average number of carbon atoms in the alkyl group is from about 11 to about 14, especially those present with a relatively low number of isomers, can provide good softness but at the same time tend to phase separate more strongly in the compositions.

14. Form and Rheology of the Compositions

As used herein, “liquid or gel-form laundry treatment composition” refers to any laundry treatment composition which is not in solid, i.e., tablet or granule, or gas, form. Examples of liquid or gel-form laundry treatment compositions include heavy-duty liquid laundry detergents for use in the wash cycle of automatic washing-machines, liquid finewash and liquid color care detergents such as those suitable for washing delicate garments, e.g., those made of silk or wool, either by hand or in the wash cycle of automatic washing-machines. The corresponding compositions having flowable yet stiffer consistency, known as gels, are likewise encompassed. Other liquid or gel-form laundry treatment compositions encompassed herein include dilutable concentrates of the foregoing compositions, unit dose, spray, pretreatment (including stiff gel stick) and rinse laundry treatment compositions, or other packaged forms of such compositions, for example those sold in single or dual-compartment bottles, tubs, or polyvinyl alcohol sachets, and the like. The compositions herein suitably have a sufficiently fluid rheology that they may be dosed either by the consumer, or by automated dosing systems controlled by domestic or commercial laundry appliances. Stiff gel forms may be used as pretreaters or boosters, see for example U.S. 20040102346A1, or may be dispensed in automatic dispensing systems, for example through being dissolved in-situ in the presence of a stream of water.

In general the fabric treatment compositions herein may be isotropic or non-isotropic, however they do not generally split into separate layers such as phase split detergents described in the art. A preferred laundry treatment composition is non-isotropic and on storage said composition is either (i) free from splitting into two layers or, (ii) if said composition splits into layers, a single major layer is present and said major layer comprises at least about 90% by weight, preferably more than about 95%, more preferably more than about 99% of the composition. Other preferred compositions are fully isotropic.

“Gel” as used herein includes a shear thinning gel with a pouring viscosity in the range of from 1,000 to 5,000 mPas (milli Pascal seconds), more preferably less than 3,000 mPas, most preferably less than 1,500 niPas. Gels include thick liquids. More generally, a thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick under low shear (e.g., at rest) and thin at high flow rates. The rheology of shear-thinning gels is described in more detail in the literature, see for example WO04027010A1 Unilever.

Other compositions according to the present invention are pourable gels preferably having a viscosity of at least 1,500 mPa·s but no more than 6,000 mPa·s, more preferably no more than 4,000 mPa·s, still more preferably no more than 3,000 mPa·s and especially no more than 2,000 mPa·s.

Yet other compositions according to the present invention are non-pourable gels preferably have a viscosity of at least 6,000 mPa·s but no more than 12,000 mPa·s, more preferably no more than 10,000 mPa·s, still more preferably no more than 8,000 mPa·s and especially no more than 7,000 mPa·s.

Preferred liquid or gel form laundry treatment compositions herein include heavy-duty liquid laundry detergents for use in the wash cycle of automatic washing-machines and liquid finewash and/or color care detergents; these suitably have the following rheological characteristics: viscosity of no more than 1,500 mPa·s, more preferably no more than 1,000 mPa·s, still more preferably, no more than 500 mPa·s. Very suitable compositions have viscosity of from 30 to 400 mPas and are either Newtonian or shear-thinning. In these definitions and unless specifically indicated to the contrary, all stated viscosities are those measured at a shear rate of 21 s-1 and at a temperature of 25° C.

Viscosity herein can be measured with any suitable instrument, e.g., a Carrimed CSL2 Rheometer at a shear rate of 21 sec⁻¹.

15. pH

The laundry treatment compositions of the present invention can in general have a wide range of pH however, below about pH 7 the technical problems of amine off-odor are diminished so that the invention is somewhat less useful and above about pH 9 the compositions may be harsh on clothes. The preferred compositions, which are those which are most subject to a technological problem of amine off-odors and therefore, which benefit to the greatest degree from the instant invention, are those which have a moderately alkaline pH. Under alkaline pH, a greater proportion of amine impurities are non-protonated and therefore, volatile. Moreover, alkaline pH can be helpful especially in heavy-duty liquid laundry detergents, to improve cleaning. As used herein, “alkaline pH” refers to a pH of from about 7 to about 10. Preferably, the laundry treatment compositions of the present invention have a pH of from about 7.5 to about 9, most preferably from about 7.5 to about 8.5. pH's of fully formulated products herein are generally measured using a pH meter, without dilution (sometimes called “neat pH). pH's of wash-baths, obtained after substantial dilution of the product in wash water, may differ, and indeed preferably do.

16. Use

An effective amount of the liquid detergent compositions herein added to water to form aqueous laundering solutions can comprise amounts sufficient to form from about 500 to 7,000 ppm of composition in aqueous washing solution. More preferably, from about 1,000 to 3,000 ppm of the detergent compositions herein will be provided in aqueous washing solution.

The compositions of this invention, prepared as hereinbefore described, can be used to form aqueous washing solutions for use in the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith.

An effective amount of the liquid detergent compositions herein added to water to form aqueous laundering solutions can comprise amounts sufficient to form from about 500 to 7,000 ppm of composition in aqueous washing solution. More preferably, from about 1,000 to 3,000 ppm of the detergent compositions herein will be provided in aqueous washing solution.

For additional information as to suitable adjuncts for use herein, the reader is referred to copending and published patent applications from Procter and Gamble relating to liquid laundry compositions, especially those comprising fabric softeners or enhancers and/or perfume additives.

### EXAMPLES

The following examples illustrate the compositions of the present invention but are not necessarily meant to limit or otherwise define the scope of the invention herein.

In examples A, B, C, D and E of Table I according to the invention, the fabric treatment composition provided is a liquid laundry detergent and the non-enzymatic nitrogen containing component is a nitrogenous fabric benefit agent, specifically it is coco trimethylammonium chloride having good odor and which is obtainable from Akzo, Degussa or other suitable suppliers. Specific suitable materials include Armosoft 12W ex Akzo or comparable material ex. Degussa, supplied typically as 37% active material in water. If in doubt concerning volatile amine impurity levels, check with the supplier or analyse the received materials for dimethylamine/trimethylamine using conventional methods. The composition is made by mixing the components.

Mixing sequence: The ingredients are mixed in any order subject to the conditions that the pH is maintained in the range 6 to 8 throughout mixing and the cocotrimethylammonium chloride is added at a pH above 7.5 and after the fatty acid.

This results in unperfumed forms of the compositions. The unperfumed forms are evaluated for amine off-odor, before the indicated levels of perfume are added. Note that for industrial application, the perfume can alternately be added at any stage of mixing.

TABLE I
Examples A-E

| | | (invention) | | | | |
|---|---|---|---|---|---|---|
| | | A | B | C | D | E |
| Non-enzymatic nitrogen | Coco trimethylammonium chloride | 1.0 | 5.0 | 3.6 | 5.0 | 3.0 |
| containing component | | | | | | |
| Solvent system | | | | | | |
| Non-water part | Ethanol | 8.0 | 5.0 | 9.3 | 11.0 | 9.3 |
| | 1,2 propanediol | 5.0 | 6.0 | 5.9 | 9.0 | 6.0 |
| | MEA | 5.2 | 6.0 | 4.2 | 6.5 | 5.0 |
| | Sodium cumene sulfonate | 1.5 | 3.0 | 1.4 | 3.0 | 2.0 |
| Water part | Water | 50.00 | 40.00 | 45.00 | 30.00 | 40.00 |
| Nonsoap | Nonionic C35EO7 | 8.0 | 8.0 | 9.0 | 13.5 | 1.0 |
| surfactant | HLAS | 5.0 | 0.0 | 6.0 | 9.0 | 0.0 |
| | C25 AE2.5S | 2.0 | 7.0 | 0.0 | 0.0 | 20.0 |
| Soap surfactant | C1218 fatty acid | 3.2 | 5.0 | 5.3 | 12.0 | 3.0 |
| Electrolyte (chelant) | Diethylenetriamine | 0 | 0.10 | 0.15 | 0.15 | 0.10 |
| | penta(methylenephosphonic acid) | | | | | |
| | 1-Hydroxyethylidene-1,1- | 0 | 0.20 | 0.25 | 0.30 | 0.20 |
| | diphosphonic acid | | | | | |
| Adjuncts | Citric Acid | 0 | 2.0 | 1.5 | 1.5 | 2.0 |
| | Alpha Amylase (activity 26.3 mg/g) | 0 | 0.05 | 0.05 | 0.08 | 0.05 |
| | Protease (activity 40.6 mg/g)*** | 0 | 0.30 | 0.35 | 0.45 | 0.30 |
| | Boric acid (for buffering, enzyme | 0 | 1.0 | 1.0 | 1.5 | 1.0 |
| | stabilization and as preservative) | | | | | |
| | Tetraethylenepentamine EO 15-18 | 0 | 1.0 | 1.0 | 1.5 | 1.0 |
| | NaOH | 0.10 | 0.10 | 0.10 | 0.15 | 0.10 |
| | Minor ingredients | Balance | Balance | Balance | Balance | Balance |
| Perfume | | 0.20 | 0.25 | 0.30 | 0.30 | 0.30 |
| Ppm DMA/TMA (1) | | Less than | Less than | Less than | Less than | Less than |
| | | 500 ppb | 500 ppb | 500 ppb | 500 ppb | 500 ppb |
| Odor grade (2) | | OK | OK | OK | OK | OK |
| Result in test for | | Visually clear - | Visually clear - | Visually clear - | Visually clear - | Visually clear - |
| stability (3) | | no precipitate | no precipitate | no precipitate | no precipitate | no precipitate |
| | | or phase split | or phase split | or phase split | or phase split | or phase split |

| | |
|---|---|
| pH | All compositions are in the range 8.0-8.5 |

***Protease is a high-active (40.6 mg/g) commercially available protease B ex. Genencor.

Tests:

(1) DMA/TMA level and odor trade calibration by spiking experiment: Reference compositions not containing the nitrogenous fabric care agent nor a perfume, are prepared in “spiking” experiments by mixing the ingredients of the composition together. The resulting composition is split in three identical parts and to these is added, respectively (1) no TMA, (2) 200 ppb of TMA on a weight basis and (3) 500 ppb of TMA on a weight basis, using a stock solution containing 0.004 w/w % TMA in demineralized water. The resulting three “TMA-spiked” reference compositions are evaluated by a panel of 2 experienced perfumers yielding the following product odor assessment results: Product 1 (no TMA)—perfumers assess as “solventy”; Product 2 (100 ppb TMA)—perfumers assess as “traces of amine+solventy character”; Product 3 (500 ppb of TMA)—perfumers assess as “strong fishy-amine odor plus solventy character.

(2) Odor grade—The series of TMA-spiked reference compositions is prepared in an analogous manner for each of A-E (in each instance omitting nitrogenous fabric care agent and perfume). the Using the results from the spiked reference compositions as a guide, the perfumers assess the products of the invention A-E (in each case containing the non-enzymatic nitrogen containing component but no perfume) and find them acceptable in odor grade, i.e., NOT having excessively fishy-amine or solventy character. In other words the results for each invention formula A-E are in line with reference Product having 100 ppb TMA.

(3) Test for Stability

Conventional storage testing to meet Japanese conditions, including (a) 12 weeks, 20° C. storage and separately, 5 freeze-thaw cycles.

### Comparative Example F

### Not According to the Invention

Substantially pure dodecyltrimethylammonium hydroxide free from chloride ion is prepared by known literature methods and the pure material is placed in the hexagonal phase using the known phase behavior. This is added to compositions similar to A-E except that the dodecyltrimethylammonium hydroxide replaces the coco trimethylammonium chloride and is added last. On storage at 20° C., the detergents acquire a distinct and unpleasant amine odor.

What is claimed is:

1. A liquid laundry detergent composition, comprising a non-enzymatic nitrogen-containing component that is capable of having a short-chain amine impurity, and comprising a solvent system capable of promoting dissolution of said nitrogen-containing component while minimizing the tendency of said solvent system to create amine impurity off-odors: wherein the composition comprises;
(a) the non-enzymatic nitrogen-containing component wherein said component is capable of having a short-chain amine impurity and wherein said component comprises less than about 10 ppm of the short-chain amine impurity; and
(b) the solvent system; and
(c) wherein the composition further comprises at least one of the following conditions:
(i) the composition is substantially free of enzyme;
(ii) the composition comprises a compatible enzyme preparation;
(iii) the composition comprises an odor sweetener;
(iv) the composition is substantially free of condensed phases which are capable of decomposing said non-enzymatic nitrogen-containing compound in the detergent composition to produce short-chain amine impurities; and/or
(v) said non-enzymatic nitrogen-containing component is purified prior to incorporation into said liquid laundry detergent composition.

2. A liquid laundry detergent composition according to claim 1 wherein said component comprises less than about 500 ppb of said short-chain amine impurity and the liquid laundry detergent composition further comprises an additional laundry detergent component selected from:
(i) perfumes;
(ii) a fatty acid or salt thereof;
(iii) a laundry adjunct, selected from antibacterial agents, malodor counteractants, cyclodextrins, deodorant perfume ingredients, dry fabric odor-enhancing technologies, other nonsilicone fabric softeners or enhancers, silicone fabric softeners or enhancers, deposition aids, thickeners and mixtures thereof; and
(iv) mixtures thereof.

3. A liquid laundry detergent composition according to claim 2 wherein the composition comprises a fatty acid or salt thereof complexed with said non-enzymatic nitrogen-containing component.

4. A liquid laundry detergent composition according to claim 1 having a neat pH of at least 7 when diluted at 1% in water, wherein the composition is substantially free from condensed phases capable of decomposing said non-enzymatic nitrogen-containing compound so as to produce additional short-chain amine impurities.

5. A liquid laundry detergent composition according to claim 4 wherein at least one condensed phase of said non-enzymatic nitrogen-containing component is a hydroxide-containing hexagonal phase comprising alkyltrimethylammonium.

6. A liquid laundry detergent composition according to claim 1, wherein the composition comprises a perfume at a level of not more than 0.7%, by weight of the liquid laundry detergent composition and further comprises an odor sweetener.

7. A liquid laundry detergent composition according to claim 1 wherein the solvent system, is not exclusively water and is not exclusively an alkanolamine and said solvent system has a water part and a nonwater part, and wherein the level of the nonwater part of said solvent system is from at least 1% to no more than about 30%, by weight of the liquid laundry detergent composition.

8. A liquid laundry detergent composition according to claim 7 wherein the solvent system comprises, in the nonwater part, both an ionizable hydrotrope and an alcohol having a boiling point above that of methanol.

9. A liquid laundry detergent composition according to claim 8 wherein the alcohol is selected from propylene glycol, glycerol, ethanol, and mixtures thereof.

10. A liquid laundry detergent composition according to claim 9 wherein said solvent system comprises, in the nonwater part, from about 2.5% to about 7%, by weight of the liquid laundry detergent composition, of alkanolamine wherein said alkanolamine is in salt form.

11. A liquid laundry detergent composition according to claim 7 wherein said solvent system has a flashpoint above 40° C. in closed cup and comprises:
from about 20% to about 50%, by weight of the liquid laundry detergent composition, of water;
and, as said nonwater part of said solvent system, from about 0.1% to about 7%, by weight of the liquid laundry detergent composition, of monoethanolamine;
from about 0.1% to about 3%, by weight of the liquid laundry detergent composition, of ionizable hydrotrope selected from sodium cumene sulfonate;
from about 2% to about 20%, by weight of the liquid laundry detergent composition, of an alcohol selected from ethanol, propanediol, glycerin and mixtures thereof, provided that ethanol is not the sole alcohol.

12. A liquid laundry detergent composition according to claim 1 comprising:
(a) at least 1.0%, by weight of the liquid laundry detergent composition, of said non-enzymatic nitrogen-containing component; and
(b) less than 0.1%, by weight of the liquid laundry detergent composition, of an active enzyme protein.

13. A liquid laundry detergent composition according to claim 1 comprising:
(a) at least 1.0%, by weight of the liquid laundry detergent composition, of said non-enzymatic nitrogen-containing component; and
(b) at least 0.0001%, by weight of the liquid laundry detergent composition, of said compatible enzyme preparation.

14. A liquid laundry detergent composition according to claim 13 wherein said compatible enzyme preparation has low dry fabric odor and comprises protease B.

15. A liquid laundry detergent composition according to claim 13 wherein said compatible enzyme preparation is liquid and comprises at least 3.5% weight/weight of active enzyme protein.

16. A liquid laundry detergent composition according to claim 1 wherein said nitrogen-containing component is pretreated to reduce amine impurity content prior to incorporation in said liquid detergent composition.

17. A liquid laundry detergent composition according to claim 2 wherein said non-enzymatic nitrogen-containing component, (a), is selected from the group consisting of (i) alkyltrimethylammonium fabric softener compounds, (ii) hydroxyethyl or polyethoxylated analogs thereof, (iii) ion pair complexes thereof and (iv) mixtures therof, and is at a level of from about 1% to about 5% by weight of the liquid laundry detergent composition.

18. A liquid laundry detergent composition according to claim 1 which is visually clear.

19. A liquid laundry detergent composition according to claim 1 which is free from precipitates after 12 weeks storage at 20° C.; is free from precipitates after 5 freeze-thaw cycles; and wherein said composition comprises said component having less than 1 ppm in total of said short-chain amine impurity analyzed as trimethylamine; wherein said component is cocotrimethylammonium chloride or dodecyltrimethylammonium chloride, and wherein said composition comprises no other ingredient comprising or capable of decomposing to liberate methylamine, dimethylamine or trimethylamine.

20. A liquid laundry detergent composition according to claim 17 which is not visually clear, provided that any adjuncts affecting transparency or opacity of the detergent composition are other than precipitates formed from the recited components of the composition.

21. A liquid laundry detergent composition according to claim 20 having a weight ratio of alkyltrimethylammonium to fatty acid anion of from about 1.5:1 to about 1:6 and a neat pH of from about 7 to about 8.5.

22. A liquid laundry detergent composition according to claim 20 which is substantially free from amide surfactants and from lipase.

23. A liquid laundry detergent composition according to claim 22 additionally comprising at least 5% of an anionic surfactant selected from alkylbenzenesulfonates, alkyl poly(ethoxy)sulfates and mixtures thereof.

24. A liquid laundry detergent composition according to claim 1 additionally comprising one or more additional adjuncts selected from the group consisting of antibacterial agents, malodor counteractants, cyclodextrins, deodorant perfume ingredients, dry fabric odor-enhancing technologies, other nonsilicone fabric softeners or enhancers, silicone fabric softeners or enhancers, and mixtures thereof.
